(19) United States
(12) Patent Application Publication
(10) Pub. No.: US 2005/0180326 A1
(43) Pub. Date: Aug. 18, 2005

(54) Method and system for remotely booting a computer device using a peer device

(76) Inventors: Michael S. Goldflam, Wake Forest, NC (US); Jan Olof Roger Jonsson, West Palm Beach, FL (US); Juliano Maldaner, Delray Beach, FL (US); Sulay Bipinchandra Shah, Boynton Beach, FL (US); Frank Wang, Boca Raton, FL (US)

Correspondence Address: Kenneth A. Seaman, Esq., 219 Glen Oaks Road, Charlotte, NC, 28270, US

(21) Appl. No.: 10/778,379

(22) Filed: Feb. 13, 2004

(51) Int. Cl. H04J 1/16

(52) U.S. Cl. 370/231

(57) ABSTRACT

A system and method for providing services such as Wake-on-LAN and PXE Boot services to a multi-subnet network system which includes router and/or firewalls between different subnets. This is accomplished by using a peer computer to provide the service when performing such service is required to be transmitted across the router and/or firewall. That is, the system determines whether the service is required to go across the router and/or firewall, and, if so, to identify a computer (a peer computer) which is located on the appropriate subnet, then deliver the service to that peer computer (if necessary) and have that peer computer perform the selected service, such as Wake-on-LAN.

### FIELD OF THE INVENTION

The present invention relates generally to communications with terminals over a data transmission network. More particularly, the present invention relates to a method and system for finding and using one peer computing device to remotely and/or automatically perform on an other computing device an operation (such as wakening and/or remotely booting), even if the other computing device is located on a different subnet and communicates through an intermediate device which restricts or prevents passage of a command for the operation from the initiating device.

### BACKGROUND OF THE INVENTION

Various forms of data transmission networks are well known in the prior art. Some such data transmission networks involve datalink protocols such as Ethernet or asynchronous transfer mode (ATM) communication. The preferred embodiment of the present invention will be described in this document within the context of an Ethernet datalink protocol network, although it is not limited to such and would have similar applicability to ATM, token ring or other forms of network and subnet communication.

A set of services known collectively as the Preboot Execution Environment (PXE) provide the capabilities to remotely “boot” a software image onto a computer system over a data transmission network, prior to loading an operating system that exists locally on the machine. These PXE services can be used for a variety of functions including: recovering a software system to a previous state, installing an operating system for first time use, resetting a system to a different operating system image or migrating a system to a newer operating system image. PXE uses a Dynamic Host Configuration Protocol (sometimes referred to as DHCP), BOOTP and the Trivial File Transfer Protocol (TFTP) in order to facilitate the boot process across a network Wake-on-LAN technology enhances the PXE remote boot service process by providing the ability to turn on (or awaken) a target computer machine which had been turned off for remote boot operations without human interaction on the target computer machine. These PXE and Wake-on-LAN technologies need to fit into corporate network infrastructures which contain routers, firewalls and other DHCP servers. However, there are significant issues that need to be overcome in order to successfully deploy remote boot services such as PXE in a typical corporate network environment. In order to understand these issues and the complexity of the problem, the following brief description of a few different data transmission network topologies is given to provide an understanding of the present invention in the context of a variety of existing data transmission networks, with and without PXE services.

The simplest data transmission network involves a flat single IP subnet network, which includes no routers or firewalls that interconnect portions of the internal network Routers and firewalls are only used to connect the internal network to the outside world. This is a simple configuration for a data transmission network and one which easily accommodates remote boot services such as the PXE, however this single flat subnet network is not a typical configuration for medium to large corporate networks.

A typical flat single IP subnet network might exist without PXE services. Its Ethernet segment includes hubs, bridges, switches and other Layer 2 devices, but still appears to the network layer as a single IP subnet. There are no routers on the internal network where the client machines and the DHCP server are connected. This type of a flat single IP subnet network might include a DHCP server which provides IP addresses to clients by directly responding to each client DHCP request for an IP address.

A flat single IP subnet network as described above may be enhanced to provide the subnet with PXE services. Inclusion of the PXE services may include some or all of the functions which have been previously mentioned, including Wake-on-LAN, DHCP, BOOTP and TFTP technology which have been added to the single flat IP subnet network to implement PXE services. Wake-on-LAN is used if it is desired to turn on or awaken a target computer, such as a personal computer or PC which had been turned off. Wake-on-LAN wakes up the target PC and starts the remote boot process. A PXE boot server contains specialized DHCP services in order to respond to remote boot requests. These boot requests are embedded in the DHCP protocol. Each DHCP server is responsible for a different role in this environment. An original DHCP server continues to provide IP addresses to each client whether they are network booting or not The PXE DHCP server is responsible for providing the BOOTP server IP address to each client that is remote booting.

A higher level of complexity for a data transmission network involves a routed IP network, where one or more routers and/or firewalls interconnect portions of the internal data transmission network This type of network configuration is very common in medium to large corporations and there are significant issues to work around in order to supply remote boot services because the routers and firewalls are designed and operated to prevent the use of PXE services and other remotely initiated services from passing through. A typical routed IP data transmission network without PXE services includes an internal router between different Ethernet segments. The router is configured to relay DHCP requests to the DHCP server that is outside of the client IP subnet. DHCP requests are broadcasted on the local network segment by each client. Without a router relay function, these requests would not get off the network segment from which the request originated.

Another data transmission network configuration is a routed IP network with PXE services. This network combines the typical corporate network with remote boot services provided by one or more PXE servers. The first problem encountered with this type of data transmission network is getting any Wake-on-LAN messages to the appropriate clients located across the internal router/firewall. In order to do so, UDP or TCP ports have to be opened up on the internal router/firewall, which is a security risk. Therefore, instead of using Wake-on-LAN, typically the PC is manually woken up. The second problem is getting the DHCP requests to the PXE DHCP server. The internal router would have to be reconfigured for an application that uses PXE Boot Services to send DHCP requests to the original DHCP server and the PXE Boot Server. If the router does not support relaying to multiple DHCP servers, then the PXE Boot services will not work. Scaling this environment to one that has multiple applications that use remote boot services across multiple routers gets even more complicated and difficult to set up. Each router would have to be reconfigured for each application with remote boot services.

It might be suggested that each network subnet be provided with its own services at all times. While this would avoid the need to pass service commands through the routers/firewalls which connect the subnets, such a system could involve much unnecessary communications to establish and maintain such services. For example, the services must be established at set-up of the network and each time devices leave the network, lest the device that left the network was relied upon to provide the services such as wake-on-LAN. Since many networks have a continual change in the configuration of the network because devices are constantly leaving and joining the network keeping the services available on each subnet could be burdensome and require significant resources, which may or may not be used. It might also be suggested that each network subnet be provided with its own services at all times through dedicated, static equipment. This is also burdensome since each subnet would require significant additional resources to provide the required functionality that can otherwise be dynamically provided by peer resources that are already on the network.

Thus, the foregoing illustrates that the systems of the prior art have significant disadvantages and limitations.

### SUMMARY OF THE INVENTION

The disclosed technique overcomes the above limitations by allowing devices to be provided with remote services (awakened and/or remotely booted through a PXE server with Wake-on-LAN capabilities) in networking environments with multiple IP network segments or subnets. The technique of the present invention solves the issue of using Wake-on-LAN technology through routers and firewalls by leveraging peer devices to perform these services. It also uses peer devices to address the issue of providing DHCP services in a PXE server through routers and firewalls. This technique solves DHCP issues without requiring routers to be reconfigured or replaced to support multiple DHCP servers. Finally, it solves the problem of using multiple PXE servers without requiring the PXE servers to be aware of one another.

In today's typical networked environments, deploying PXE servers with Wake-on-LAN to remote boot computers is extremely difficult to do. Therefore, most PXE services are relegated to a controlled environment such as a lab. By solving the issues related to using PXE servers and Wake-on-LAN in a routed network, corporations can use PXE services across their entire network and leverage applications that take advantage of PXE.

The present invention also avoids the need to provide all subnets with a full complement of services and to update the services when a device is removed from the network.

The present invention also overcomes any need to identify what services may be required on what subnet and to provide those services on the identified subnet.

Other objects and advantages are inherent in the present invention and will be apparent to those of ordinary skill in the art. Thus, the limitations and disadvantages of the prior art systems are overcome by the present invention.

### BRIEF DESCRIPTION OF THE DRAWINGS

Other objects and advantages of the present invention will be apparent to those of ordinary skill in the art from the detailed description that follows along with the accompanying drawings, wherein:

FIG. 1 illustrates a data transmission network of the prior art in which a flat IP subnet is provided with PXE services;

FIG. 2 illustrates a typical data transmission network of the prior art and a DHCP server and a PXE Boot server in a multi-subnet network with an internal router;

FIG. 3 illustrates portions of a data transmission network having multiple subnets to illustrate features of the present invention to provide services to selected devices;

FIG. 4 is a flow chart that illustrates a process for performing services such as PXE operations;

FIG. 5 illustrates peer devices in a multi-subnet network; and

FIG. 6 illustrates a multi-router network with multiple PXE servers.

### DETAILED DESCRIPTION OF A PREFERRED EMBODIMENT

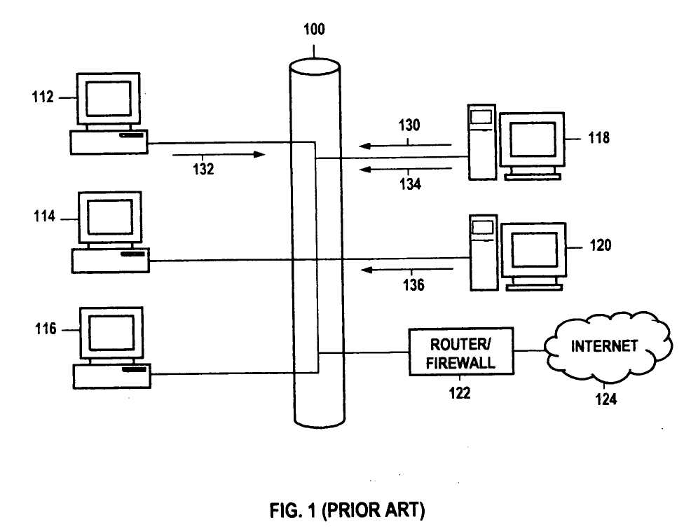

FIG. 1 illustrates a typical data transmission system of the prior art in which a flat IP subnet is provided with PXE services. As shown in this Figure, an Ethernet segment 100 has computer terminals 112, 114, 116 coupled thereto, as shown on the left-hand side of the Figure. In addition, a PXE boot server 118 and a DHCP server 120 is coupled to the Ethernet segment 100 on the right-hand side of the Figure. The Ethernet segment 100 is coupled through a router/firewall 122 to the Internet 124. Of course, the typical Ethernet segment would have a large number of computer terminals and other devices (such as printers) coupled to the segment and might have additional servers as desired coupled to the Ethernet segment 100. Also, the Ethernet segment could be connected to other networks through routers/firewalls, as desired. The computer terminals 112, 114 and 116 are, in their preferred embodiment, personal computers which have the capability of local processing and storage as well as communicating with other processors (such as a server or mainframe) through the network or Ethernet segment 100.

An arrow 130 illustrates a Wake-on-LAN message from the PXE boot server 118 which is directed, in this example, to the selected computer terminal 112. When the selected computer terminal 112 receives the Wake-on-LAN message, it broadcasts a request 132 for a client IP address and a BOOTP server address. The PXE boot server 118 replies as illustrated by the arrow 134 with the BOOTP server address which is required for the computer terminal 112 to continue the PXE boot process. The DHCP server 120 replies as illustrated by the arrow 136 with the client IP address so that the computer terminal 112 will have an IP address which is recognized and registered with the DHCP Server 120 for communication with other terminals and with the rest of the network.

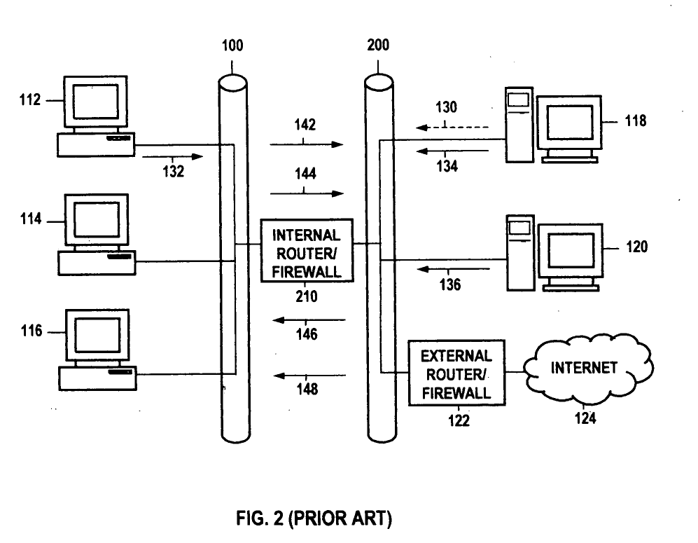

FIG. 2 illustrates another form of prior art network system in which a pair of Ethernet subnet segments are coupled together to form a network, possibly for a larger organization than the one which would use the network of FIG. 1. As shown in this Figure, the first Ethernet segment 100 has attached the three computer terminals (or personal computers) 112, 114 and 116 like in FIG. 1.

In this case, the network includes a second Ethernet subnet or segment 200 which is coupled to the first Ethernet segment 100 through an internal router/firewall 210 and has attached to the second Ethernet segment the PXE boot server 118 and the DHCP server 120. In addition, the second Ethernet subnet 200 also includes a connection to the Internet 124 through an external router or firewall 122.

As illustrated in this Figure, in some cases the PXE boot server 118 would try to send a message to a terminal 112 as illustrated by the dotted arrow 130 in FIG. 2. This message 130 would not transfer through the internal router/firewall 210 (hence the dotted lines which are intended to show a message which is sent but not completed), since one of the functions of a router/firewall 210 is to protect the devices on the other side of the firewall from attack (from improper messages or commands). Thus, a reply message such as “Error! Unable to wake computer terminal” might be provided, since the message 130 was unable to go through the firewall 210 to the terminal 118.

If terminal 112 is to be awakened, it must be awakened manually in this arrangement, then generate a message 132 to request a client IP address and a BOOTP server address, which is then relayed as message 142 to the PXE server and as message 144 to the DHCP server. The PXE boot server 118 responds with message 134 with the BOOTP server address response and the DHCP server 120 responds with message 136 with the Client IP address response which are relayed to the terminal 112 through the internal router/firewall 210 as messages 146 and 148, respectively. The messages other than the message indicated by the dotted arrow 130 are considered safe messages which are not affected by the security processes of the internal router/firewall 210, but the message 130 (to awaken the device) is considered sensitive and would not pass through a router/firewall. Message 130 is considered sensitive since it is an unsolicited request initiated from the outer Ethernet segment 200 towards the internal Ethernet segment 100. By default, firewalls protect against unsolicited requests and only allow responses to requests initiated from an internal Ethernet segment to be passed back to an internal Ethernet segment. Of course, one could turn off the security by opening the ports of the firewall, but that would destroy one security feature of the firewall/router. Though message 132 is considered a safe message, it still requires special configuration on the internal router/firewall 210 in order to properly relay DHCP requests such as message 142. If additional router/firewall devices are added to the network, each of these devices requires the additional manual configuration for each PXE server on the network.

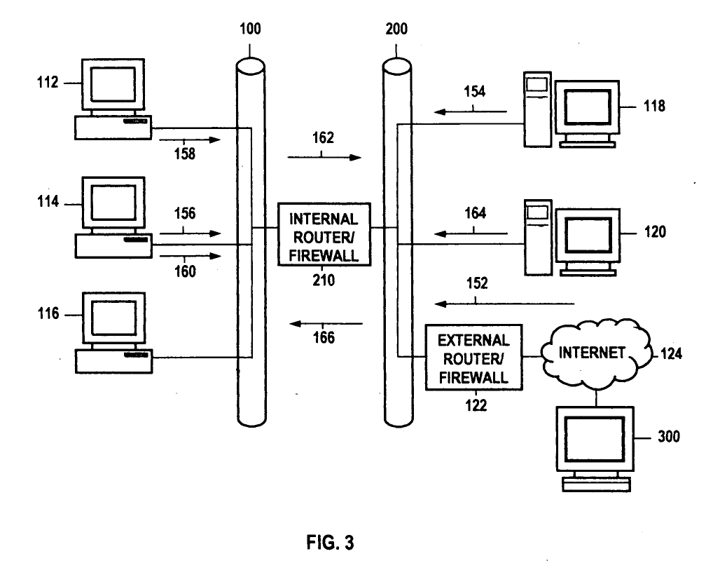

FIG. 3 illustrates a method and system to boot a device (e.g., the terminal 112) through its peer devices (the terminal 114) in a Touted network with a firewall 210 coupling the first subnet 100 with a second subnet 200 to accomplish some of the objectives of the present invention. This method and system works by dynamically placing PXE remote boot services on a peer device (the terminal 114) that is within the same local subnet as the device to be booted (the terminal 112). This solution solves the problems discussed in connection with FIG. 2 above.

In the embodiment shown in FIG. 3, two subnets 100, 200 exist, coupled by an internal router/firewall 210 where the PXE srvices are located on the PXE server or terminal 118 and the DHCP services are on the terminal 120, both of which are on the second subnet 200 whereas the terminal 112 which is to be booted is located on the first subnet 100.

The remote boot services are controlled through an external management system 300 coupled to the Internet. The services provided by the PXE Boot Server are dynamically deployed onto a peer client on the local subnet. The peer client is told which device to provide PXE Boot services to and does not respond to other clients. The peer client issues the Wake-on-LAN request on the local subnet which solves the problem of using Wake-on-LAN through routers. The peer client also responds to the booting client DHCP request to supply the BOOTP server address. This eliminates the need to reconfigure any routers to forward DHCP requests to additional servers. The rest of the PXE services such as BOOTP and TFTP are also provided by the peer device in order to download the boot image code to the destination PC. Once the PXE boot operation is complete, the peer device is told to stop responding to PXE requests.

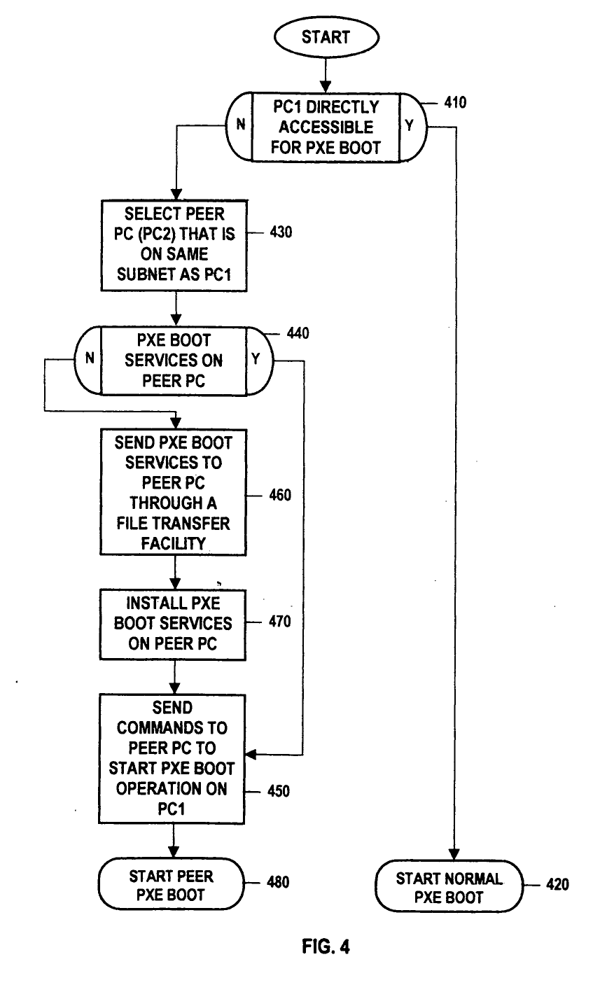

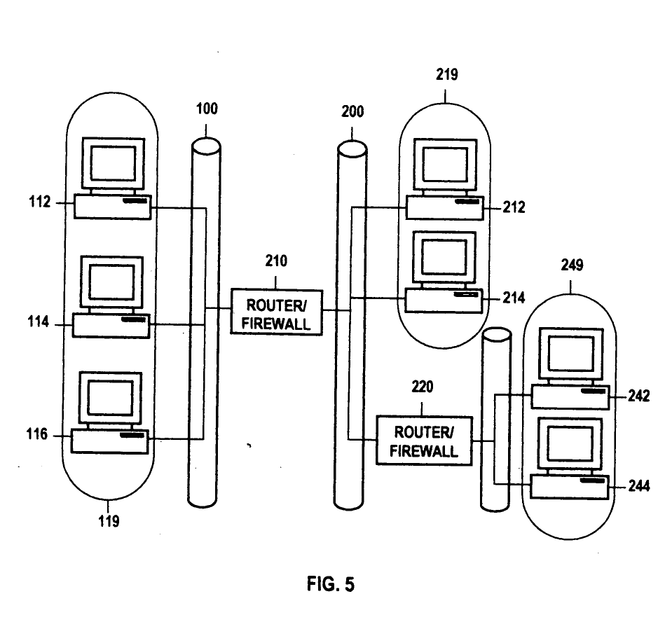

In this embodiment, the process is started when the Management System 300 decides to remote boot a PC and instructs the PXE Boot Server 118 to do so through message 152. FIG. 4 shows how the PXE Boot Server determines the best way to initiate the PXE boot process. The PXE Boot Server determines if the PC (PC1) that needs to be remote booted can be accessed directly by the PXE Boot Server. If so, the PXE boot process will be handled by the Master PXE Boot Server. If the Master PXE Boot Server cannot remotely boot PC1, it selects a Peer PC of PC1 to be the Peer PXE Boot Server. PCs are considered Peers if they can directly communicate with one another for Wake-on-LAN and other PXE boot functions. In this embodiment, PCs are considered Peers if they are on the same logical IP subnet without any routers between them as shown in FIG. 5 and described in a later section.

In FIG. 3, terminal 114 is selected as the peer for terminal 112. Once selected as the peer and provided with the appropriate instructions in the form of software, the terminal 114 acts as a proxy for the original or master PXE Boot Server 118. The PXE boot services software (instructions) are transferred to the terminal 114 as shown with arrow 154 unless the terminal 114 already has the PXE Boot Services. These services (which may include all or some of the services including a DHCP server, a BOOTP server, a TFTP server and a Wake-on-LAN service) may be automatically installed on the Peer PC, terminal 114, making it a Peer PXE Boot Server. The Master PXE Boot server 118 then informs the Peer PXE Boot Server 114 to initiate the boot process for terminal 112 by providing the Media Access Control (MAC) address of terminal 112 to the Peer PXE Boot Server 114. This MAC address message is also shown by arrow 154 in this Figure. Once the boot process is complete, the Master PXE Boot server 118 decides whether the Peer PC (terminal 114) continues to run the PXE Boot Server process for terminal 112 or for other PCs on the same IP subnet (terminal 116 in this example).

The remote boot process starts on the target PC (terminal 112) when it is turned on. The PC automatically turns on when it receives a Wake-on-LAN message which is commonly known in the industry as a “Magic Packet”. A Magic Packet is a well-formed data packet, such as an Ethernet packet, that contains within it a PC's MAC address repeated 16 times preceded by 6 bytes of FFh. When a PC that supports Wake-on-LAN sees its Magic Packet, it will wake up and start the remote boot process. If a PC's MAC address is 001122334455, then the following sequence inside an Ethernet frame will wake it up. Note that this sequence of data can be located anywhere in the data packet.
FFFFFFFFFFFF001122334455001122334455001122334455001122334455 001122334455001122334455001122334455001122334455001122334455 001122334455001122334455001122334455001122334455001122334455 001122334455001122334455

If the PXE server (e.g. terminal 118) sits outside a firewall (210) and tries to wake up a client (e.g., terminal 112) inside a firewall (as shown in FIG. 2), it will not be able to do so. Even if the Magic Packet is contained within an IP packet, the firewall 210 will prevent this packet from getting on the internal network (subnet 100 on which the terminal 112 is attached). Without the invention, the most common way to solve this problem is to manually turn on the client which requires human intervention. An alternative is to send this packet on a specific UDP or TCP port and to manually disable firewall protection for this port on all routers and firewalls (e.g., 210) the packet goes through. This will compromise the security provided by each firewall.

The disclosed technique uses a Peer PC (e.g., the terminal 114) to issue the Magic Packet. Message 156 from terminal 114 in FIG. 3 is the Magic Packet addressed for terminal 112. Since the Wake-on-LAN function is initiated by a Peer PC (terminal 114) that is inside the firewall 210 and on the same IP subnet 100 as the PC (the terminal 112) being woken, there is no firewall issue with sending the packet directly to the destination PC. When running on Ethernet, the Magic Packet from the Peer PC terminal 114 to the destination PC, the terminal 112, will use the following format if the Peer PC MAC address is 000102030405 and the destination PC MAC address is 001122334455. The MISC sections can be any data that is part of a valid Ethernet frame. CRC refers to the Ethernet CRC.
001122334455000102030405 MISC FFFFFFFFFFFF001122334455001122334455001122334455001122334455 001122334455001122334455001122334455001122334455001122334455 001122334455001122334455001122334455001122334455001122334455 001122334455001122334455 MISC CRC

Once the destination PC (terminal 112) wakes up, it goes through its normal remote boot process. This process is described in depth in “Preboot Execution Environment (PXE) Specification, Version 2.1, Intel Corp., September 1999.” PXE uses option fields in DHCP messages to provide the PXE extensions to the DHCP protocol. The first message issued by the woken PC, represented by message 158 from terminal 112, is a DHCP Discover request with an option that contains the “PXEClient” extension. This message serves two purposes. The first purpose of this request is to get its IP address from the normal DHCP server. The second purpose of this request is to get the IP address of the BOOTP server that the client needs to continue the remote boot process with. The DHCP Discover request sent by the client does not have the proper source IP address in it since this message is used by the client to find out its own IP address. The message also does not have the proper destination IP address in it since the client does not know the IP address of any of the DHCP servers. Therefore, it is up to the IP router to property relay this message to the machines providing the DHCP service. In a PXE Boot environment, there are typically multiple DHCP servers and therefore the IP router must be configured to relay the DHCP requests to both the normal DHCP server and all of the PXE Boot servers. This means that when an application that leverages PXE services is deployed in an IP network, the routers that control the IP network need to be reconfigured to forward the DHCP requests to a PXE server.

FIG. 2 depicts a very simple routed network in which there is only a single router that needs to be reconfigured. However in a typical corporate environment, there may be a very large number of routers that require reconfiguration for each PXE server that is deployed. With properly configured routers, the normal DHCP server responds with a DHCP Offer response that contains the IP address for the PC. The PXE Boot server sends a second DHCP Offer response, also known as an Extended DHCP Offer which contains the address of the BOOTP server. Since the PXE Boot server is not responsible for providing IP addresses in this example, it will return a NULL IP address in its Extended DHCP Offer to the client.

The disclosed technique, as shown in FIG. 3, solves this router configuration problem by transferring the PXE Boot services responsibility to a Peer PC. No special configuration is required on router 210 to get these requests to a PXE Boot server since the Peer PC 114 sends the Extended DHCP Offer that contains its own address as the BOOTP server in message 160. The router 210 only relays the DHCP request to the normal DHCP server with message 162, as it is always responsible to do. The Peer PC only sends the Extended DHCP Offers to those clients it is configured to respond to. This allows multiple DHCP servers to exist that respond to Extended Offers which in turn allows multiple applications to deploy their own PXE server without conflicting with other PXE servers. Only the one PXE server configured to respond to the requesting client will do so.

Once the destination PC, terminal 112, receives the Extended DHCP Offer from the PXE Boot server 114 and completes its handshaking with the normal DHCP server 120 to acquire an IP address (messages 164 and 166), it continues the boot process by issuing another DHCP Discover request to the Peer PXE Boot server 114 to determine which boot file to load. The Peer PXE Boot server responds with the appropriate boot file name in a second Extended DHCP Offer. The destination PC, terminal 112, then uses the TFTP protocol to download the boot file directly from the Peer PXE Boot server 114.

Once the boot process is complete, the Master PXE Boot server 118 turns off the PXE boot services on the Peer device (the terminal 114). When subsequent remote boot operations are required on the same IP subnet, the Master PXE Boot 118 server goes through the process again of selecting a Peer device to perform these operations. The Master PXE Boot server 118 will typically select a Peer device or terminal that already has the PXE services installed over a Peer without the PXE services installed. However, the Master PXE Boot server 118 may select a different peer device (e.g., the terminal 116 in FIG. 3) to perform these operations if a previously used peer (the terminal 114) is not currently connected to the network subnet 100. This allows the solution to be fault tolerant among peers which is especially important since devices are regularly rebooted, turned off or removed from the network. Another reason that the invention may select a different peer is that many devices may need to be remotely booted at the same time. Each peer PXE server can respond to multiple clients simultaneously. However, multiple peers may be used to efficiently load-balance the requests among the available peer resources.

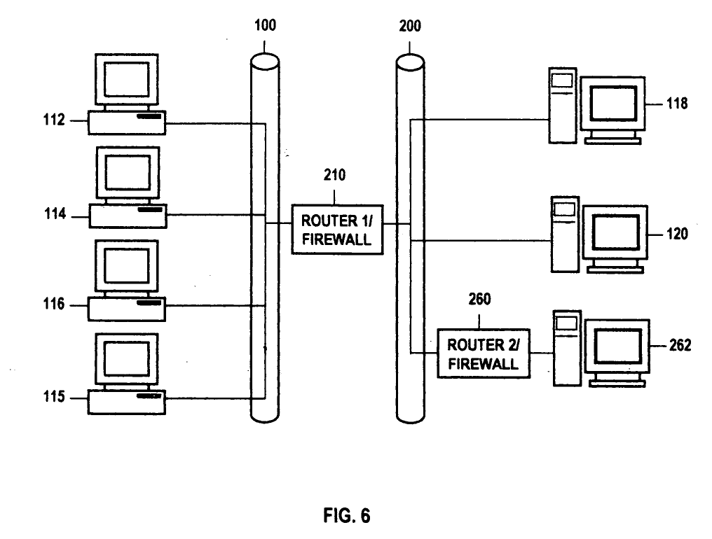

The invention also allows multiple applications that use remote boot services to work in the same corporate network without requiring these applications (or their associated remote boot servers) to communicate or be aware of one another. With the invention, each application can independently deploy PXE boot services to peers as needed. They operate independently, only respond to clients using their service and do not require each router to be reconfigured to send DHCP requests to all of the PXE boot servers. FIG. 6 illustrates a diagram of multiple PXE boot server applications. As shown in this view, a first terminal 112 is provided with a peer terminal 114 and a second terminal 116 is provided with a second peer terminal 115, all of which are attached to the first Ethernet segment 100. The second Ethernet segment 200 is coupled to the first Ethernet segment 100 through the first router/firewall 210 and has attached to it a DHCP server 118 and a first PXE Boot Server 120. A second PXE Boot server 262 is attached to the Ethernet segment 200 through a second router/firewall 260. Terminal 120 is the first PXE Boot Server and deploys PXE boot services to terminal 114 to respond to boot requests from terminal 112. Terminal 262 is the second PXE Boot Server and deploys PXE boot services to terminal 115 to respond to boot requests from terminal 116. Neither of the PXE Boot servers are aware of the other. Without the invention, Router 210 would have to be configured to forward DHCP requests to the DHCP server and both PXE boot servers and Router 260 would have to be configured to forward DHCP requests to the second PXE Boot server, terminal 262. There would also have to be a mechanism put in place for each PXE Boot Server to know whether it should respond to each client boot request.

FIG. 4 is a flow chart which illustrates one flow of logic for the present invention. In this situation, when it is determined that services such as PXE boot services (e.g., Wake-on-LAN) are desired for a particular terminal PC1, the block 410 determines whether that terminal PC1 has the service accessible to it (for example, on the same subnet or within the firewall or router). If so, then control proceeds to block 420 where the normal services such as the PXE boot services are provided to the terminal PC1.

If the selected terminal for the services is determined not directly available (for example, not on the same subnet or with an intermediate firewall or router) at the block 410, then at block 430 a peer terminal or personal computer PC2 is selected which is on the same subnet as the particular terminal PC1 (or is otherwise accessible to the particular terminal PC1 without an intervening firewall or router). Then, block 440 determines whether the selected service (e.g., PXE Boot service) is available from that peer terminal PC2. If so, then the service is used at block 450. If not, then at block 460 code to implement the service is sent using a file transfer facility (one which will go through the firewall or router such as, but not limited to, a client initiated FTP session). That code to implement the PXE Boot facility then is installed at block 470 on the peer terminal PC2 and then the service is started at block 450 to provide the service to the particular terminal PC1, which services are then implemented at block 480.

FIG. 5 illustrates a somewhat different network depicted for the purpose of describing the peer groupings of terminals useful in the present invention. The present network is shown with three subnets and three sets of peer terminals, although the same concept could be extended to any number of subnets and peer groupings of terminals. As shown here, the network includes the first Ethernet segment or subnet 100 and the second Ethernet segment or subnet 200 similar to the network of FIG. 3, but in which a third Ethernet segment or subnet 240 is attached to the second subnet 200 through a router/firewall 220. A first peer grouping of terminals 119 comprises the terminals 112, 114 and 116 which are attached to the first Ethernet segment or subnet 100, a second peer grouping of terminals 219 comprising the terminals 212, 214 which are attached to the second subnet 200 and a third peer grouping of terminals 249 comprises the terminals 242, 244 which are attached to the third subnet 240. Terminals in group 119 are “peers” since they can send messages directly to one another at the IP protocol level. They do not need to go through an IP router or firewall to communicate. Terminal 112 and 212 are not “peers” since they cannot send messages directly to one another at the IP protocol level. They must go through IP router or firewall 210 in order to communicate. Not shown in this Figure are the various servers which are associated with the present invention or any connection to the Internet, although such would normally be present.

Of course, many modifications to the preferred embodiment will be apparent to those who work in the relevant art. For example, the services being provided have been discussed using PXE services such as Wake-on-LAN, DHCP and BOOTP, but, in fact, the present invention is not so limited and this invention can be used to advantage with any type of services which are filtered, prevented, altered or hindered across a firewall or router. Further, the present invention has been described in the environment of Ethernet network protocols where it is also useful in other types of networks such as asynchronous transfer mode (ATM) or other communications protocols such as IPX or Appletalk. Further, it may be advantageous to use certain components of the present invention without the corresponding use of other components which have been disclosed as a part of the preferred embodiment. As an example, there may be applications that only need to provide a Wake-on-LAN service through a peer machine to force a device to boot into its core operating system. The present invention is described in the context of routers and firewalls, which may be implemented in either hardware or software or in some combination thereof. Further, the description of a routed network may, itself, be as a result of using hardware or software combined with hardware. Thus, the foregoing description should be considered as merely illustrative of the principles of the present invention and not in limitation thereof, as the present invention is defined solely in the following claims.

1. A method of providing a service to a target device, the steps of the method comprising:
determining a service to be provided to a target device coupled to a subnet;
determining if the service is available on the subnet to which the target device is coupled;
if the service is available on the subnet to which the target device is coupled, using the service;
if the service is not available on the subnet, locating a peer device on the subnet;
transferring the service to the peer device; and
using the service on the peer device to operate on the target device.

2. A method including the steps of claim 1 wherein the method includes steps for providing the service to a target device from within the subnet to which the target device is attached.

3. A method including the steps of claim 1 wherein the subnet to which the target device is attached is coupled to a firewall which restricts the service from being implemented through the firewall.

4. A method including the steps of claim 1 wherein the subnet to which the target device is attached is coupled to a router which restricts the service from being implemented through the router.

5. A method including the steps of claim 1 wherein providing the services includes the step of remotely wakening a computer.

6. A method including the steps of claim 6 where providing the services includes the step of providing DHCP services to the target computer.

7. A method including the steps of claim 6 where providing the services includes the step of providing BOOTP services to the target device.

8. A method including the steps of claim 6 wherein the service includes the step of providing TFTP services to the target computer.

9. A system for providing services on a network comprising:
a first subnet including a target terminal and a peer terminal coupled thereto;
a second subnet including a device which wishes to operate on the target terminal;
a device connecting the first subnet and the second subnet which restricts passage of operations;
a locator which identifies the peer terminal;
a determiner which determines whether the peer terminal includes the desired service;
if the peer terminal does not include the desired service, a package which includes the service; and
an instruction to the peer terminal to implement the service on the target terminal.

10. The system of claim 9 wherein the connecting device is a router.

11. The system of claim 9 wherein the connecting device is a firewall.

12. The system of claim 9 wherein the determiner operates based on knowledge of what devices are attached to the network and what services those devices include.

13. A method of using a first computer with a program for waking up a second computer across a routed network having a subnet coupled to a router, the steps of the method comprising:
determining whether the first computer is on the same subnet as the second computer;
if the first and second computers are on the same subnet, using the first computer to send a command to the second computer to wake the second computer;
if the first and second computers are not on the same subnet, determining whether a peer computer on the same subnet as the second computer is available and, if it is, using the peer computer to waken the second computer.

14. A method including the steps of claim 13 wherein the method further includes the step of determining whether the peer computer includes the wakening code and, if not, sending the wakening code to the peer computer.

15. A method including the steps of claim 13 wherein the routing network includes a firewall which restricts the passage of a wakening message through the firewall.

16. A method of providing a service to a selected terminal attached to a network which includes a firewall device which is intended to prevent certain commands from being transmitted through the firewall device where the services needs for the commands to pass through the firewall device, the steps of the method comprising:
determining the selected terminal to which the desired service is to be provided;
determining whether the desired service is available on a terminal on the same subnet as the selected terminal;
if the desired service is not available on the same subnet as the selected terminal, identifying a peer terminal on the same subnet with the desired terminal for which the service is to be provided;
transmitting a package which can provide the service to the peer terminal; and
using the peer terminal to provide the desired service to the selected terminal, whereby the use of the package and the peer terminal allows for the service to pass through the firewall device.

17. A method of providing a DHCP request to a first computer on a first subnet which is coupled to a device which restricts the passage of certain commands, the steps of the method comprising:
determining whether the first subnet has a computer attached thereto with DHCP capabilities;
if the first subnet includes a computer with DHCP capabilities, using those DHCP capabilities to provide a DHCP request to the first computer through the first subnet;
if the first subnet does not include a computer with DHCP capabilities, then locating a second computer on the same first subnet as the first computer and downloading a DHCP program to the second computer; and
using the second computer to provide a DHCP request to the first computer.

18. A computer program for providing a service to a computer attached to a subnet where the subnet is attached to a router which restricts the passage of certain commands and the computer program has the capability to invoke the commands without reconfiguring the router, the computer program having s program on media which includes:
a first module for determining a function which is required on a subnet;
a second module which determines whether the function is available on the subnet;
a third module which loads a program for effecting the required function onto a peer computer on the subnet if the function is not available on the subnet; and
a fourth module which uses the loaded program on the peer computer to invoke the commands on another computer located on the same network, where the commands would not pass through the router without router configuration but can be called from the program which has been loaded on the peer computer to provide the determined function.

19. A computer program for providing a service to a first computer attached to a subnet where the subnet is attached to a router which restricts the passage of certain commands including commands associated with the service, the computer program has the capacity to effect the service without intervention by a user, the computer program having stored instructions on a media and including:
a first module for determining a command which is desired to be sent to the first computer but which can not be sent from the subnet to which the first computer is attached;
a second module for locating a peer computer to the first computer and attached to the same subnet as the first computer;
a third module for downloading to the peer computer an executable program which includes a command which can not pass though the router without intervention by the user; and
a fourth module which executes the executable program at the peer computer and causes the peer computer to issue the command to the first computer and allows the command to pass to the first computer since the first computer and the peer computer are located on the same subnet and within the router, whereby the command is issued to the first computer without user intervention to allow the command to pass through the router.
